(19) United States
(12) Patent Application Publication
(10) Pub. No.: US 2009/0088527 A1
(43) Pub. Date: Apr. 2, 2009

(54) ATTACH PASTE COMPOSITION FOR SEMICONDUCTOR PACKAGE

(75) Inventors: Joon-Mo Seo, Suwon-si (KR); Byoung-Un Kang, Seoul (KR); Jae-Hoon Kim, Seoul (KR); Ji-Eun Kim, Gunpo-si (KR); Jun-Woo Lee, Suwon-si (KR)

Correspondence Address: STROOCK & STROOCK & LAVAN LLP, 180 MAIDEN LANE, NEW YORK, NY, 10038, US

(73) Assignee: LS Mtron Ltd., Anyang-city (KR)

(21) Appl. No.: 12/238,634

(22) Filed: Sep. 26, 2008

(30) Foreign Application Priority Data
Sep. 28, 2007 (KR) 10-2007-0098120

(51) Int. Cl. C08L 63/00

(52) U.S. Cl. 525/187; 525/403

(57) ABSTRACT

The present invention relates to an attach paste composition for a semiconductor package. The attach paste composition for a semiconductor package includes a mixed resin, or a blend of an elastic resin and an epoxy resin as a basic resin. At this time, preferably the basic resin includes 50 to 95 weight % of the elastic resin and 5 to 50 weight % of the epoxy resin. The present invention enables a conventional semiconductor packaging method using a die adhesive to eliminate a pre-drying process performed after application of a die adhesive through screen printing and a thermal hardening process performed after an encapsulation process, maintains the properties of the die adhesive, ensures reliability of semiconductor products, and realizes a simple process.

### CROSS-REFERENCE TO RELATED APPLICATION

This application claims priority to Korean Patent Application no. 10-2007-0098120 filed on Sep. 28, 2007 the entirety of which is incorporated herein by reference.

### TECHNICAL FIELD

The present invention relates to an attach paste composition for a semiconductor package, and in particular, to an attach paste composition for a semiconductor package which uses a mixed resin, or a blend of an elastic resin and an epoxy resin as a basic resin, passes through a semi-curing process before a die attaching process, and can prevent damage of products and realize a simple process.

### BACKGROUND

A die attach paste has a wide application as an adhesive used in stacking chips or attaching a chip to a support member such as PCB (Printed Circuit Board) or a lead-frame in a semiconductor device packaging process.

A semiconductor package may be manufactured by a series of steps. A semiconductor die or chip is electrically connected to a substrate, and the semiconductor die or chip is also mechanically connected to the substrate by an adhesive. The substrate is connected to another electrical device or an external power source. Alternatively, a semiconductor die or chip is mechanically connected to a substrate by an adhesive, and may be preserved for a predetermined period of time.

In the case that a semiconductor package is manufactured by a series of steps, an adhesive is applied on a substrate, a semiconductor chip is attached to the adhesive and the adhesive is cured by heat or both heat and pressure. A solvent-free liquid or paste type adhesive or a solid type adhesive may be appropriate. The liquid or paste type adhesive is cured and solidified by heating. Meanwhile, in the case that an adhesive is applied on a substrate, semiconductor packaging is stopped and a subsequent assembly process is deferred to a later time, a solid type adhesive is appropriate for complete preservation. The solid type adhesive is liable to minimum or little bleeding, and can accurately control the thickness of a bondline, i.e. an interface between the semiconductor chip and the adhesive, and a die tilt.

In some semiconductor package applications, a paste adhesive is preferable to a film adhesive for a procedural reason. However, the paste adhesive needs bondline and fillet control. In this case, an adhesive known as a B-stageable adhesive may be used. In the case that an adhesive material is solid, the solid is dispersed or dissolved in a solvent to form a paste, and the paste is applied on a substrate. Subsequently, the adhesive is heated to vaporize the solvent, so that a non-cured solid type adhesive remains on the substrate. In the case that an adhesive material is liquid or paste, the adhesive is applied on a substrate, heated and partially cured into a solid state.

Such a die adhesive is applied on a member in a predetermined pattern through screen printing, passes through B-stage curing process, is left for 1 day or more at normal temperature and passes through a pre-drying process to remove any remaining moisture before die attaching. The pre-drying process can prevent voids that may occur due to moisture remaining in the die adhesive at a subsequent high temperature process, and thus it is indispensable to a conventional semiconductor packaging method. After a die attaching process is completed, a curing process is performed to improve heat resistance and reliability of the die adhesive. Finally, after a wire-bonding process is completed, an encapsulation process using an epoxy molding compound (EMC) is performed to protect the attached chip, and a thermal hardening process is performed to improve heat resistance and adhesion of the EMC.

As mentioned above, from application of the die adhesive to encapsulation (protection using an encapsulation material), the conventional semiconductor packaging method needs several heating processes. This goes against process efficiency and is not economical. The related industry has attempted to simplify the process, and the present invention was devised under this technical background.

### SUMMARY

It is an object of the present invention to provide an attach paste composition for a semiconductor package which enables a conventional semiconductor packaging method using a die adhesive to eliminate a pre-drying process and a thermal hardening process, ensures stability, reliability, heat resistance and adhesion of semiconductor products, and realizes a simple process.

According to the present invention, an attach paste composition for a semiconductor package includes a mixed resin, or a blend of an elastic resin and an epoxy resin as a basic resin. At this time, preferably the basic resin includes 50 to 95 weight % of the elastic resin and 5 to 50 weight % of the epoxy resin. Preferably, the elastic resin is any one of rubber-based materials, any one of urethane-based materials or mixtures thereof. More preferably, the rubber-based materials include butadiene rubber, acrylonitrile butadiene rubber, hydrogenated acrylonitrile butadiene rubber, glycidylacrylate rubber, carboxyl terminated butadiene rubber, vinyl terminated butadiene rubber, amine terminated butadiene rubber, silicon acryl rubber, silicon rubber, polybutylene terephthalate rubber and styrene butadiene rubber, and the urethane-based materials include polycaprolactone-based urethane, polyester-based urethane and polyether-based urethane.

Meanwhile, preferably the attach paste composition for a semiconductor package further includes 1 to 20 parts by weight of a curing agent based on 100 parts by weight of the epoxy resin. Preferably, the attach paste composition for a semiconductor package further includes 30 to 100 parts by weight of a reactive diluent based on 100 parts by weight of the basic resin.

It is preferable to change the properties of the attach paste composition for a semiconductor package by a semi-curing process and then use the attach paste composition to a semiconductor attaching process. At this time, more preferably the attach paste composition for a semiconductor package has a change ratio of 50 to 100% in amount of heat generation before and after the semi-curing process. Meanwhile, in the attach paste composition for a semiconductor package after the semi-curing process, more preferably a strength of adhesion to a semiconductor is 10 kgf/cm² or more, and a ratio of an area adhered with the semiconductor to the entire area is 60 to 100%. And, in the case that the attach paste composition for a semiconductor package after the semi-curing process is left for 1 day under conditions of 85° C. temperature and 85% humidity, more preferably a moisture absorption rate of the attach paste composition for a semiconductor package is maintained to 0.5% or less. Further, in the attach paste composition for a semiconductor package after the semi-curing process, more preferably a glass transition temperature (Tg) is 10 to 150° C., and a storage modulus at normal temperature (25° C.) is 10⁴ to 10¹⁰ Pa.

### BRIEF DESCRIPTION OF THE DRAWINGS

The present invention will be more fully described in the following detailed description, taken accompanying drawings, however, the description proposed herein is just a preferable example for the purpose of illustrations, not intended to limit the scope of the invention.

FIG. 1 is a flow chart illustrating a semiconductor packaging method according to the present invention.

### DETAILED DESCRIPTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

To achieve the above-mentioned object, an attach paste composition for a semiconductor package includes a basic resin including an elastic resin and an epoxy resin, a curing agent and a reactive diluent. If necessary, the attach paste composition may further include well-known additives for various additional functions.

Preferably, the basic resin includes 5 to 50 weight % of an elastic resin and 50 to 95% of an epoxy resin. That is, a mixed resin, or a blend of an elastic resin and an epoxy resin is used as a basic resin. A blending ratio of components in the basic resin is controlled to increase durability and heat resistance and decrease moisture absorption after a curing process.

At this time, preferably the elastic resin content in the basic resin is 50 to 95 weight %, and the epoxy resin content in the basic resin is 5 to 50 weight %. Meanwhile, preferably the elastic resin may be any one of rubber-based materials, any one of urethane-based materials or mixtures thereof, however the present invention is not limited in this regard. The rubber-based materials may include butadiene rubber, acrylonitrile butadiene rubber, hydrogenated acrylonitrile butadiene rubber, glycidylacrylate rubber, carboxyl terminated butadiene rubber, vinyl terminated butadiene rubber, amine terminated butadiene rubber, silicon acryl rubber, silicon rubber, polybutylene terephthalate rubber and styrene butadiene rubber. The urethane-based materials may include polycaprolactone-based urethane, polyester-based urethane and polyether-based urethane.

Preferably, the attach paste composition for a semiconductor package further includes 1 to 20 parts by weight of a curing agent based on 100 parts by weight of the epoxy resin. The curing agent may be acid anhydride-based, amine-based, peroxide-based or phenol-based, however the present invention is not limited in this regard. The content of the curing agent may vary according to kind of the curing agent. The above-mentioned content range is general to effectively increase the crosslinking density in a curing reaction of the curing agent and epoxy. In the case that the content of the curing agent is less than the minimum, although a curing reaction occurs at a predetermined temperature, the crosslinking density is lowered and heat resistance is remarkably decreased, thereby reducing reliability. On the contrary, in the case that the content of the curing agent is more than the maximum, a portion of curing agent that is not reacted after a curing reaction acts as impurity, which decreases the crosslinking density, thereby reducing reliability.

And, preferably the attach paste composition for a semiconductor package further includes 30 to 100 parts of a reactive diluent by weight based on 100 parts by weight of the basic resin. The diluent may be ketone-based, ester-based, ether-based, alcohol-based or chlorine-based, however the present invention is not limited in this regard. In the case that the content of the reactive diluent is less than the minimum, it is not preferred because flow is poor in a printing process and consequently printability is reduced. On the contrary, in the case that the content of the reactive diluent is more than the maximum, it is not preferred because the shape is not maintained after a printing process.

Preferably, after properties of the attach paste composition for a semiconductor package are changed by a semi-curing process, the attach paste composition is used to a semiconductor attaching process. More preferably, for wide temperature range and high thermal stability, the attach paste composition for a semiconductor package has a change ratio of 50 to 100% in amount of heat generation before and after the semi-curing process. Meanwhile, to provide sufficient adhesive strength and such durability that the attach paste composition is not damaged in a subsequent encapsulation process using an epoxy molding compound (EMC) although the attach paste composition is not additionally cured, more preferably the attach paste composition after a semi-curing process has an strength adhesion to a semiconductor of 10 kgf/cm² or more. And, more preferably the attach paste composition for a semiconductor package after a semi-curing process has wettability such that an area adhered with a semiconductor to the entire area is 60 to 100%. Further, in the case that the attach paste composition after a semi-curing process is left for 1 day under conditions of 85° C. temperature and 85% humidity, more preferably the attach paste composition for a semiconductor package has a moisture absorption rate of 0.5% or less. And, more preferably, the attach paste composition for a semiconductor package after a semi-curing process has a glass transition temperature (Tg) between 10 and 150° C., and a storage modulus at normal temperature (25° C.) between 10⁴ and 10¹⁰ Pa.

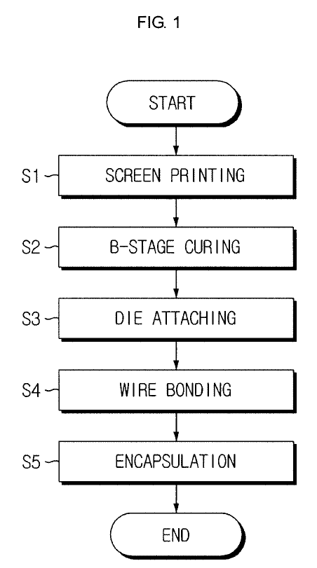

A semiconductor packaging method using the attach paste composition for a semiconductor package according to the present invention performs steps S1 to S5 of FIG. 1.

FIG. 1 is a flow chart illustrating a semiconductor packaging method using a composition according to the present invention.

(S1) Screen-Printing Step

A screen-printing process is performed on a member, for example a PCB substrate or a lead-frame to apply a die adhesive to an upper surface of the member.

(S2) B-stage Curing Step

B-stage curing process is performed on the member having the die adhesive. The B-stage curing process may be performed using heat or UV (UltraViolet) singularly or in combination sequentially or simultaneously. In this embodiment, the B-stage curing process is performed using heat. Preferably, the B-stage curing process is performed at temperature between 140 and 180° C. for 60 to 120 minutes.

The B-stage curing process is performed to make a curing reaction of the die adhesive by 50 to 100%. The B-stage curing process uses a die adhesive, of which the degree of cure is controlled to show a decrease of 50 to 100% in amount of heat generation before and after the B-stage curing process. The degree of cure may be measured by a differential scanning calorimetry (DSC). At this time, preferable analysis condition is a decrease in amount of heat generation when the degree of cure of the die adhesive is measured with a temperature increasing speed fixed at 10° C./min.

Preferably, in the case that the die adhesive after the B-stage curing process is left for 1 day or more under conditions of 85° C. temperature and 85% humidity, the die adhesive has a moisture absorption rate of 0.5% or less. If the die adhesive satisfies the above-mentioned conditions, the semiconductor packaging method does not need preliminary process conditions that are indispensable to a conventional semiconductor packaging method. However, the performance of the die adhesive of the present invention is not influenced.

(S3) Die Attaching Step

A die is attached on the B-stage cured die adhesive. An amount of heat generation decreased 50 to 100% in the B-stage curing process, however after a die attaching process, the die adhesive maintains its adhesive strength to 10 kgf/cm² or more at normal temperature. In the die attaching process, wettability of the die adhesive is controlled such that an area adhered with the die to the entire area for adhesion is 60 to 100%.

The die adhesive after the B-stage curing process has a glass transition temperature (Tg) between 10 to 150° C. and a storage modulus at normal temperature (25° C.) between 10⁴ and 10¹⁰ Pa. If the glass transition temperature conditions and the storage modulus conditions of the die adhesive are satisfied, the semiconductor packaging method according to the present invention does not need a thermal hardening process of the die adhesive that is indispensable to a conventional semiconductor packaging method.

(S4) Wire-Bonding Step

The attached die and the member are wire-bonded to each other.

(S5) Encapsulation Step

The outside of the wire-bonded resultant is encapsulated. For encapsulation, an encapsulation process using an epoxy molding compound (EMC) is generally used. If the above-mentioned process conditions and property conditions required for the die adhesive are satisfied, the semiconductor packaging method does not need a separate thermal hardening process used to improve heat resistance of an encapsulation material and the die adhesive, but can meet the required property conditions.

According to results of MRT (Moisture Resistance Test) of a Pb free version based on JEDEC (Joint Electron Device Engineering Council) standard, a semiconductor product produced through the above-mentioned steps has a preferable reliability of level 2 or more.

The samples were manufactured by the above-mentioned method according to conditions of Table 1, the rates of moisture absorption of the samples were tested, and the test results are as follows.

TABLE 1

| | | | | Comparative | Comparative | Comparative |
|---|---|---|---|---|---|---|
| Classification | Example 1 | Example 2 | Example 3 | example 1 | example 2 | example 3 |
| Rubber/(Rubber + Epoxy)(%) | 55 | 75 | 95 | 75 | 45 | 25 |
| B-stage curing conditions | 140° C. | 180° C. | 150° C. | 130° C. | 150° C. | 150° C. |
| | 30 minutes | 30 minutes | 30 minutes | 30 minutes | 30 minutes | 30 minutes |
| Rate of moisture absorption | 0.48 | 0.45 | 0.42 | 0.55 | 0.45 | 0.45 |
| (%) | | | | | | |

Meanwhile, properties at each step of a semiconductor packaging process were evaluated, and the evaluation results are shown in the following Table 2.

TABLE 2

| | | | | Comparative | Comparative | Comparative |
|---|---|---|---|---|---|---|
| Classification | Example 1 | Example 2 | Example 3 | example 1 | example 2 | example 3 |
| Strength of | 11 | 20 | 25 | 15 | 0.5 | 0.1 |
| adhesion to die | | | | | | |
| (kgf/cm²) | | | | | | |
| Wire bonding | good | good | good | void generation | good | good |
| characteristics | | | | | | |
| EMC | good | good | good | void generation | void generation | void generation |
| characteristics | | | | | | |
| MRT reliability | good | good | good | crack | popcorn | popcorn |
| (Level. 2) | | | | | generation | generation |

It was found through Table 1 that differences in technical features between the examples 1 to 3 and the comparative examples 1 to 3 were not too large. However, it was found through Table 2 that the examples 1 to 3 showed good results in all properties, but the comparative examples 1 to 3 did not reach the standard value in at least two items and had factors for deteriorating the properties.

Hereinabove, preferred embodiments of the present invention has been described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An attach paste composition for a semiconductor package,
wherein a mixed resin, an elastic resin and an epoxy resin are blended and used as a basic resin.

2. The attach paste composition for a semiconductor package according to claim 1,
wherein the basic resin includes 50 to 95 weight by percent of the elastic resin and 5 to 50 weight by percent of the epoxy resin.

3. The attach paste composition for a semiconductor package according to claim 2,
wherein the elastic resin is any one of rubber-based materials, urethane-based materials or mixtures thereof.

4. The attach paste composition for a semiconductor package according to claim 3,
wherein the rubber-based materials include butadiene rubber, acrylonitrile butadiene rubber, hydrogenated acrylonitrile butadiene rubber, glycidylacrylate rubber, carboxyl terminated butadiene rubber, vinyl terminated butadiene rubber, amine terminated butadiene rubber, silicon acryl rubber, silicon rubber, polybutylene terephthalate rubber and styrene butadiene rubber, and
wherein the urethane-based materials include polycaprolactone-based urethane, polyester-based urethane and polyether-based urethane.

5. The attach paste composition for a semiconductor package according to claim 1, further comprising:
1 to 20 parts by weight of a curing agent based on 100 parts by weight of the epoxy resin.

6. The attach paste composition for a semiconductor package according to claim 1, further comprising:
30 to 100 parts by weight of a reactive diluent based on 100 parts by weight of the basic resin.

7. The attach paste composition for a semiconductor package according to claim 1,
wherein, after properties of the attach paste composition for a semiconductor package are changed through a semi-curing process, the attach paste composition is used to a semiconductor attaching process.

8. The attach paste composition for a semiconductor package according to claim 7,
wherein the attach paste composition for a semiconductor package has a change ratio of 50 to 100% in amount of heat generation before and after the semi-curing process.

9. The attach paste composition for a semiconductor package according to claim 8,
wherein, in the attach paste composition for a semiconductor package after the semi-curing process, a strength of adhesion to a semiconductor is 10 kgf/cm² or more, and
wherein, in the attach paste composition for a semiconductor package after the semi-curing process, a ratio of an area adhered with the semiconductor and an entire area of the composition applied for adhesion is 60 to 100%.

10. The attach paste composition for a semiconductor package according to claim 8,
wherein, in the case that the attach paste composition for a semiconductor package after the semi-curing process is left for 1 day under conditions of 85° C. temperature and 85% humidity, a moisture absorption rate of the attach paste composition for a semiconductor package is maintained to 0.5% or less.

11. The attach paste composition for a semiconductor package according to claim 8,
wherein, in the attach paste composition for a semiconductor package after the semi-curing process, a glass transition temperature is 10 to 150° C., and
wherein, in the attach paste composition for a semiconductor package after the semi-curing process, a storage modulus at normal temperature is 10⁴ to 10¹⁰ Pa.
